(19) United States
(12) Patent Application Publication
(10) Pub. No.: US 2006/0248176 A1
(43) Pub. Date: Nov. 2, 2006

(54) Method of discovering a service running on a computing device and connecting a client running on a different computing device to said service

(76) Inventors: Ian McDowall, Cambridge (GB); Jeremy Pavier, Suffolk (GB)

Correspondence Address: SYNNESTVEDT LECHNER & WOODBRIDGE LLP, P O BOX 592, PRINCETON, NJ, 08542-0592, US

(21) Appl. No.: 10/559,782

(22) PCT Filed: Jun. 10, 2004
(86) PCT No.: PCT/GB04/02471

§ 371 Date: May 25, 2006

(30) Foreign Application Priority Data
Jun. 10, 2003 (GB) 0313375.8

(51) Int. Cl. G06F 15/173

(52) U.S. Cl. 709/223

(57) ABSTRACT

In an implementation of the invention, services installed on a computing device register their published name, which conforms to a structured naming convention, such as reversed domain information, with a ‘service broker’ on that device. The service broker uses a single well-known port number address. When an external client, connected to the computing device that has a service broker, wants to use a service on that computing device, it sends a message to the service broker using the well known port number. The message specifies the name of the desired server and requests that the service broker inform it of the appropriate connection point (e.g. port number) to use. There is no dependency on port numbers or unstructured and arbitrary naming conventions.

### BACKGROUND TO THE INVENTION

1. Field of the Invention

This invention relates to a method of connecting a client running on a computing device to a server running on a different computing device.

2. Description of the Prior Art

When a client (i.e. a program making a request for a service) wishes to connect to a server (i.e. the program that can supply the requested service) over a network, it needs to uniquely identify the service. The standard approach relies on the use of ‘port numbers’. In essence, a port number is a logical address: when one program communicates with another program on a different computer, it specifies the port number of that program in each data transmission so that its messages can be properly received by the correct program. For instance, HTTP normally uses port number 80: all HTTP messages from a client are uniquely identified by the client specifying port 80.

This approach requires manual configuration (i.e. the developer of the client program has to manually select a, port number, with ICANN designating the so-called ‘well-known’ port numbers 0 to 1023; registered ports running from 1024 to 49151 and private ports running from 49152 to 65535). It also risks clashes between servers. (i.e. if two developers choose the same port number). Nevertheless, this approach is workable for services provided by OS or device manufacturers because those port numbers can be fixed when a device is manufactured. However, Independent Software Vendors (ISVs) cannot reserve these port numbers and so the conventional approach makes it difficult for ISVs to create new services since they face the risk of port number allocations being duplicated, with the risk of clashes arising.

### SUMMARY OF THE PRESENT INVENTION

In an implementation of the invention, services installed on a computing device register their published name, which conforms to a structured naming convention, such as reversed domain information, with a ‘service broker’ on that device. The service broker uses a single well-known port number address. When an external client, connected to the computing device that has a service broker, wants to use a service on that computing device, it sends a message to the service broker using the well known port number. The message specifies the name of the desired server and requests that the service broker inform it of the appropriate connection point (e.g. port number) to use. There is no dependency on port numbers or unstructured and arbitrary naming conventions.

Because service names are made unique by using a structured (and preferably standard and open) naming convention, e.g. by pre-pending the service name with reversed domain information, new connectivity services can be added to devices without having to change the existing configuration of the device. Address clashes are avoided as long as new services use the service broker and a consistent naming convention.

If a service is registered with the name specified by a client to the service broker, then the service broker starts the service. The service obtains a connection point by some means and informs the service broker of the connection point address (for TCP/IP this would be a port number, other transport mechanisms (e.g. Bluetooth, serial, USB, IrDA etc.) would have other addressing mechanisms). The service broker then informs the external client of the connection point address of the service. The client then communicates directly with the server, unlike some prior art approaches, where the intermediary stays in position. With this mechanism the only statically allocated address is that of the service broker.

If a service is required more than once, the server will not be re-started: instead the service broker uses cached address information.

When services register with the service broker, they may register a version number to indicate the version of the service that they are providing (and, optionally, other information and how they can be started). The external client can request a specific version of a named service or it can omit the version, in which case the service broker will start the highest version available of the named service. In either case, the service broker informs the remote client of the version of the service that has been started. This allows a remote client to inter-operate with a range of devices and potentially handle different versions of services.

The service broker can serve external clients that are PC's or other computers connected by a local link such as cable, Infra-Red or short distance radio (such as Bluetooth) or by a remote link such as a network data connection.

The service broker can provide authentication information such that only authenticated external clients can access services.

The service broker does not require administration, it is extensible and resolves port clashing by using names instead of numbers and names can be easily made unique by using internet domain information.

It provides mechanisms for handling and publishing service version numbers and thus allows one client to handle a range of devices.

SymbianOS from Symbian Limited deploys an implementation of the present invention. Examples of service names, originating from within Symbian Limited, that conform to the structured naming convention include the following:

com.symbian.scrfs; where ‘scrf’ is the Symbian Connect Remote Filing System.

com.symbian.swinstall—the remote software install service

com.symbian.syncmlinit—the syncML initiation service

An example of a third-party service might be

uk.co.ian_mcdowall.pim for a PIM interface service owned by ian_mcdowall.co.uk

or

com.big_company.sales_manage for a sales management service provided by big_company.com

### Appendix 1

Introduction

Purpose and Scope

The purpose of this Appendix 1 is to describe the functionality provided by the Service Broker.

The Service Broker provides a mechanism for remote clients to start various service providers (socket servers using the TCP/IP protocol suite and communicating via a protocol that must have been defined between client and server) on the device and to retrieve the port number for these services. It also manages connection authentication, between the device and a remote client. Remote clients are requested to authenticate the connection before starting named services on the device.

Overview Context

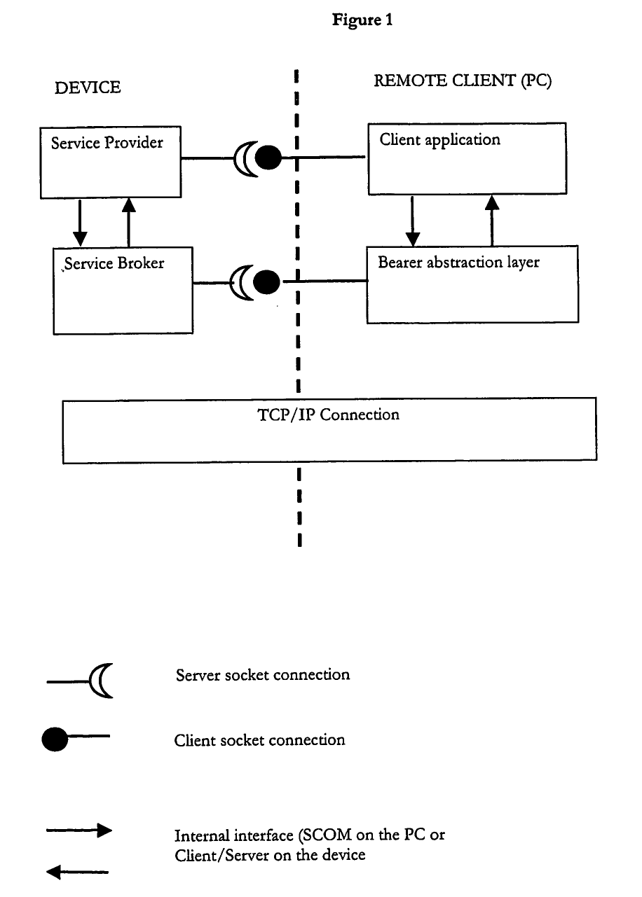

FIG. 1 shows the Service Broker in its architectural context. The Bearer Abstraction Layer (BAL) running on the remote client connects to the server socket provided by the Service Broker. The remote client is usually a Windows PC but it can be any device capable of establishing a TCP/IP connection to the device.

An application on the remote client requests the service port number from the BAL. The BAL requests this port number from the Service Broker via a messaging protocol. The name of the service is specified by the client to the BAL and by the BAL to the Service Broker.

The Service Broker attempts to start the Service Provider (if not already running) and to retrieve its port number. This is achieved via the Client Server API.

Once the Service Provider has been started, the Service Broker transmits the port number to the BAL, which in turn communicates it to the client application. The client application can then establish a direct connection to the Service Provider.

Functionality

Functionality for the Service Broker is expressed as a set of use cases, which are triggered by the external interfaces. Interfaces are just referred to as actors in this section.

For brevity, the Service Broker is referred to as the system in the rest of this section.

Actors

The following actors can be identified:
The remote client, sending requests on the socket interface and receiving responses to its requests. These requests are formatted according to the messaging protocol.
The Service Provider, connecting to the client server interface and communicating a port number for each service it supports.
The password provider DLL.
   Use Cases

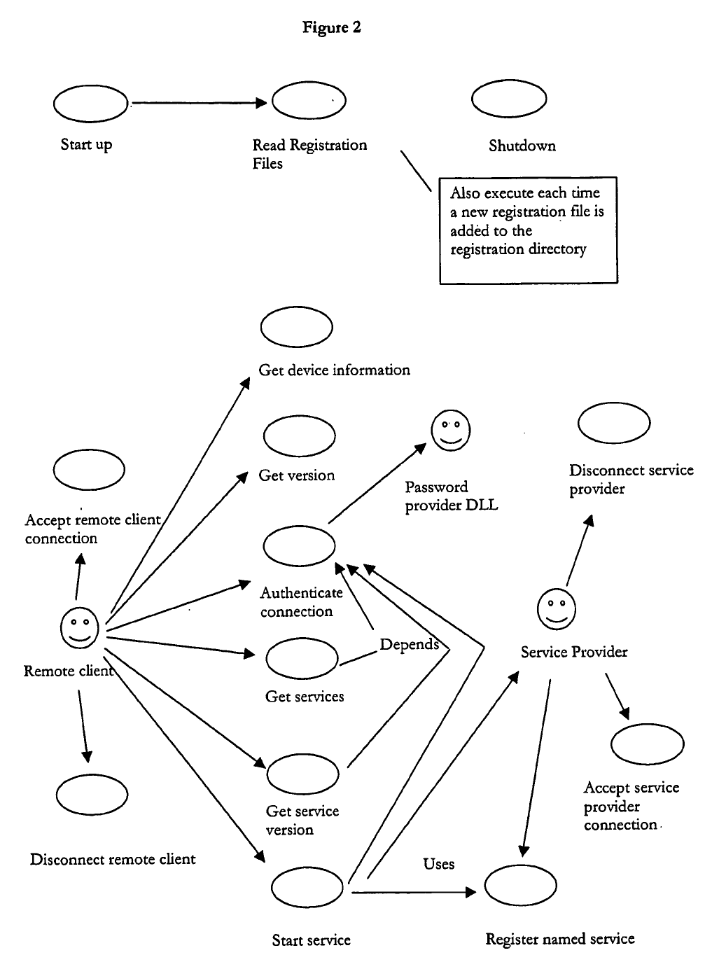

FIG. 2 illustrates top-level use cases, which comprise the entire functionality of this system. These use cases are described in the following sections.

Startup

| | |
|---|---|
| Pre-condition | The system is not running. |
| Description | The system is started up, this is usually done |
| | during the device startup procedure. |
| Normal | Execute “Read Registration Files”. |
| Execution Flow | Read the bearer configuration file. This file |
| | specifies if connections over a certain physical |
| | medium require authentication or can be considered |
| | automatically authenticated. In order to |
| | authenticate a connection, device and PC must |
| | supply an identical password. This is described |
| | more in “Authenticate Connection”. If a |
| | bearer is automatically authenticated (e.g. this |
| | might be the case for Serial and USB bearers) then |
| | there is no need to execute “Authenticate |
| | Connection” for connections over that bearer. |
| | Connections over bearers that do require |
| | authentication need to execute “Authenticate |
| | Connection” each time the physical link is |
| | established. |
| | Start the client server interface. |
| | Open the server socket on the specified port. |
| Post-condition | The system is now running. |
| Exceptions | If the socket connection cannot be opened, log |
| | an error and terminate. |
| | If the server cannot be started, log an error |
| | and terminate. |
| | If the registration directory cannot be accessed, |
| | log an error and terminate. |

Read Registration Files

| Pre-condition | The system is starting up or a new file has been |
|---|---|
| | added to, updated or removed from the registration |
| | area. This area is constituted of two directories. |
| | Both directories have the same path but are |
| | located on different drives with one of them being |
| | the ROM drive. The files contained in the |
| | registration directory located on the ROM drive |
| | are loaded only at startup and before any other |
| | registration files. Only the registration |
| | directory on the non-ROM drive is monitored for |
| | further file updates. |
| Description | Registration files contain the binding between |
| | service names (specified by the clients on the |
| | remote socket) and the information needed to start |
| | up a process that implements those services. |
| | Registration files can be updated, added to or |
| | removed from the non-ROM registration directory |
| | at any time. |
| | The information read from registration files is |
| | stored in a table, the services table. There is |
| | one entry for each service containing the following:- |

Service Name;
Process Name (the name of the process that
implements this service);
Exe Location (full path and file name for
the exe file implementing the process).
Command line arguments (the command line
arguments to be used when starting the process).
Service Version (minor, major and build number).
Registration file name (the name of the
registration file that specifies the service name:
This is not specified in the file itself but it
is stored in the table because a service can be
overwritten later on only if it is in the same
registration file. Also, if registration files
are deleted, the services corresponding to this
file will be removed from the table).

| Normal | If starting up scan the ROM registration directory. |
|---|---|
| Execution Flow | Scan the non-ROM registration directory. |
| | For every xml file that has been removed: |
| | The services belonging to the file are removed |
| | from the table. |
| | For every file that has been added or updated:- |
| | Open the file and parse it. |
| | Store the service into the services table. There |
| | can be more than one service defined in a |
| | registration file. |
| | Close the file |
| Post-condition | The services table is up to date with the |
| | registration directory. |
| Exceptions | A registration file cannot be opened, in this case |
| | log an error and ignore the registration file. |
| | The syntax of a registration file is wrong, in |
| | this case log an error and ignore the registration |
| | file. |
| | A registration file specifies a service name, |
| | which is already registered. In this case, only |
| | update the services table if the registration |
| | file is the same, otherwise log an error and |
| | ignore this service. |
| | A registration file specifies a service name more |
| | than once. In this case override the previous |
| | service information, only keep the one read last. |
| | However, log an error message. |

Shutdown

| | |
|---|---|
| Pre-condition | The System is running. |
| Description | The System is asked to terminate, this is usually |
| | done during the device shutdown procedure. |
| Normal | Stop the client server interface disconnecting |
| Execution Flow | any active sessions. |
| | Disconnect all the connected remote clients. |
| | Close the server socket. |
| | Terminate execution. |
| Post-condition | The system has terminated. |
| Exceptions | None. |

Accept Remote Client Connection

| | |
|---|---|
| Pre-condition | “Startup” has completed successfully. |
| Description | Accept a connection from a remote client. |
| Normal | Create a new client socket. |
| Execution Flow | Receive messages on the socket. |
| Post-condition | There is a new client socket. |
| Exceptions | The client socket cannot be created. In this case |
| | the client connection request is not accepted |
| | and an error is displayed. |
| | An unrecognised message is received, in this |
| | case discard the message and log and error. |

Get Device Information

| | |
|---|---|
| Pre-condition | “Accept Remote Client Connection” has |
| | completed successfully. |
| Description | A “Get Device Information” message has been |
| | received from the remote client. |
| Normal | Read the message header. |
| Execution Flow | Retrieve the device information (from interfacing |
| | to the HAL). |
| | Compose “Device Information” and send it to |
| | the client. |
| | The message ID of the outgoing message must be |
| | the same as the one received in the incoming message. |
| Post-condition | The message has been handled. |
| Exceptions | The device information cannot be retrieved for |
| | some reason. In this case, compose an error |
| | message and send it to the client. The error code |
| | is “Internal Failure”. |

Get Version

| | |
|---|---|
| Pre-condition | “Accept Remote Client Connection” has |
| | completed successfully. |
| Description | A “Get Version” message has been received |
| | from the remote client. |
| Normal | Read the message header. |
| Execution Flow | Compose “Device Version” and send it to the |
| | client. |
| | The message ID of the outgoing message must be |
| | the same as the one received in the incoming message. |
| Post-condition | The message has been handled. |
| Exceptions | None. |

Authenticate Connection

| | |
|---|---|
| Pre-condition | “Accept Remote Client Connection” has |
| | completed successfully. The connection is not |
| | authenticated. |
| Description | An “Authenticate Connection” message has |
| | been received from the remote client. |
| Normal | Read the message header and generate a random |
| Execution Flow | number. |
| | Send the random number to the client in a |
| | “Random Value” message. Wait for a |
| | “Password” message from the client. |
| | When “Password” is received from the |
| | client communicate the random number to the |
| | password provider DLL and retrieve a hash of |
| | the password and the random number. Compare |
| | this hash with the one received from the |
| | remote client in the “Password” command. |
| | If the two hashes are the same then send a |
| | “Connection Authenticated” message to the |
| | client. This indicates that any connection |
| | received from the client (from the same IP |
| | address and on the same physical bearer) should |
| | be considered authenticated until the physical |
| | link is dropped. |
| Post-condition | The connection is authenticated. |
| Exceptions | If the hash supplied by the client is not the |
| | same as the hash created by the password |
| | provider DLL send an error message to the |
| | client, with code “Authentication Failed”. |
| | If the hash cannot be retrieved from the |
| | password provider DLL, send an |
| | error message to the client with code |
| | “Authentication Failed” and log an |
| | error message as well. |

Get Services

| | |
|---|---|
| Pre-condition | “Accept Remote Client Connection” has |
| | completed successfully. The connection is |
| | authenticated. |
| Description | A “Get Services” message has been received |
| | from the remote client. |
| Normal | Read the message header. |
| Execution Flow | Retrieve the list of services from the services |
| | table. |
| | Compose “Services” and send it to the client. |
| | The message ID of the outgoing message must be |
| | the same as the one received in the incoming |
| | message. |
| Post-condition | The message has been handled. |
| Exceptions | No services are available. In this case return |
| | a “Services” message with an empty list. |
| | The connection is not authenticated, in this |
| | case return to the client an error message with |
| | code “Not Authenticated”. |

Get Service Version

| | |
|---|---|
| Pre-condition | “Accept Remote Client Connection” has |
| | completed successfully. The connection is |
| | authenticated. |
| Description | A “Get Service Version” message has |
| | been received from the remote client. |
| Normal | Read the message header and extract the |
| Execution Flow | service name from the message data. |
| | Retrieve the version supported for this service |
| | from the services table. |
| | Compose “Service Version” and send it to |
| | the client. |
| | The message ID of the outgoing message must be |
| | the same as the one received in the incoming |
| | message. |
| Post-condition | The message has been handled. |
| Exceptions | The specified service is not in the services table. |
| | In this case send an error message to the |
| | client with error code “Not Found”. |
| | The connection is not authenticated, in this |
| | case return to the client an error message with |
| | code “Not Authenticated”. |

Start Service

| | |
|---|---|
| Pre-condition | “Accept Remote Client Connection” has |
| | completed successfully. The connection is |
| | authenticated. |
| Description | A “Start Service” message has been received |
| | from the remote client. |
| Normal | Read the message header and extract the service |
| Execution Flow | name. Also extract a timeout value. |
| | Check if the process associated with this service |
| | (the Service Provider) is already running. Use |
| | the information stored in the services table to |
| | do this. |
| | If the process is not running start the process |
| | and a timer using the timeout extracted above. |
| | When the Service Provider registers itself, send |
| | its port number to the client in a “Service |
| | Started” message and stop the timer. |
| | At the expiry of the timer send an error to the |
| | client with code “Failed to Register”. |
| | The message ID of the outgoing message must be |
| | the same as the one received in the incoming message. |
| | If the Service Provider is already running then |
| | compose “Service Started” and send it to |
| | the client. The port number is stored in the |
| | services table. |
| | The message ID must be the same as the one |
| | received in the incoming message. |
| Post-condition | The message has been handled and the requested |
| | Service Provider is running. |
| Exceptions | The specified service is not in the services |
| | table. In this case send an error message to |
| | the client with code “Not Found”. |
| | The process cannot be started. In this case |
| | send an error message to the |
| | client with error code “Cannot Start”. |
| | When registering itself, the process may |
| | communicate a failure code instead of a port |
| | number. This can be done via the API. In this |
| | case send an error message to the client with |
| | error code “Cannot Start” and with extended |
| | error code equal to the error received from the |
| | process. |
| | The connection is not authenticated, in this |
| | case return to the client an error message |
| | with code “Not Authenticated”. |

Disconnect Remote Client

| | |
|---|---|
| Pre-condition | “Accept Remote Client Connection” has |
| | completed successfully. The client closes the |
| | socket or an unrecoverable error occurs or |
| | execution is terminated for the entire system. |
| Description | The client connection is closed. |
| Normal | Close the socket connection and release any |
| Execution Flow | resources. |
| Post-condition | The client has been disconnected. |
| Exceptions | None. |

Accept Service Provider Connection

| | |
|---|---|
| Pre-condition | “Startup” has completed successfully. |
| Description | A new client session is established. |
| Normal | Establish a new session with the client. |
| Execution Flow | |
| Post-condition | A new client is connected to the Client Server Interface. |
| Exceptions | None. |

Register Service Provider

| | |
|---|---|
| Pre-condition | “Accept Service Provider Connection” has |
| | completed correctly. “Start Service” may |
| | be ongoing, but not necessarily. |
| Description | The Service Provider communicates the port |
| | number corresponding to the specified service name. |
| Normal | Retrieve the service name and port number from |
| Execution Flow | the Service Provider. |
| | Verify that the executable file of the client |
| | (full path and file name) is the same as the exe |
| | in the services table for the specified service name. |
| | Store the port number in the services table. |
| | If one or more client requests are pending for |
| | this service, send the service port number to the |
| | clients for all the pending requests; note however |
| | that a client may only have one pending request |
| | at a time. |
| Post-condition | The port number has been added to the services table. |
| Exceptions | The service name is not found in the table, in this |
| | case return an error. This can happen if the |
| | service name has no registration file associated |
| | with it. |
| | The service name already has a port number assigned |
| | to it. In this case override the port number with |
| | the new value and log an error. This can happen |
| | when a named service is started, then it terminates, |
| | then it is started again and so forth. |
| | Instead of communicating a port number, the |
| | Service Provider communicates a startup failure |
| | code. This is possible using the API. In this |
| | case update the services table with the failure |
| | code and set the port number to 0 (invalid port |
| | number). |

Disconnect Service Provider

| | |
|---|---|
| Pre-condition | “Accept Service Provider Connection” has |
| | completed successfully. |
| Description | The client session terminates. |
| Normal | Close the client session and release any |
| Execution Flow | resources associated with it (except for the |
| | information stored in the services table). |
| Post-condition | The client has been disconnected from the client |
| | server interface. |
| Exceptions | None |

Glossary

The following technical terms and abbreviations are used within this document.

| Term | Definition |
|---|---|
| API | Application Programming Interface |
| BAL | Bearer Abstraction Layer |
| HAL | Hardware Abstraction Layer |
| IP | Internet Protocol |
| TCP | Transport Control Protocol |

1. A method of enabling a client, running on a first computing device that is connected to a second computing device, to use a service on that second computing device, comprises the steps of:
(a) a service, installed on the second computing device, registering its published name with a service broker on that second computing device;
(b) the client sending a message to the service broker specifying the name of the service;
wherein the published name of the service conforms to a structured naming convention that uniquely identifies the service as a service from a particular vendor, but without specifying the connection point address of that service, to enable the service broker to start up the service without the risk if a clash.

2. The method of claim 1 in which the structured naming convention uses reversed domain information.

3. The method of claim 1 in which the service broker uses a single well-known port number address so that the client needs only this well known port number to send a message to the service broker.

4. The method of claim 1 in which the service obtains a connection point and informs the service broker of the connection point address and the service broker then informs the client of the connection point address.

5. The method of claim 4 in which the service broker informs the client of the connection point address and the client then uses that address in communicating directly with the server.

6. The method of claim 4 in which the connection point address is a port number.

7. The method of claim 4 in which, if a service is required more than once, the server providing the service will not be re-started, but instead the service broker uses cached address information.

8. The method of claim 1 in which, when services register with the service broker, they register a version number to indicate the version of the service that they are providing.

9. The method of claim 8 in which the client can request a specific version of a named service or it can omit the version, in which case the service broker will start the highest version available of the named service.

10. The method of claim 1 in which the service broker enables multiple services installed on a single, second computing device to serve one or more external clients that are PCs or other computers connected by a local link such as cable, Infra-Red or short distance radio (such as Bluetooth) or by a remote link such as a network data connection.

11. The method of claim 1 in which the service broker provides authentication information such that only authenticated external clients can access services.

12. A computing device that is connected to a first computing device, the computing device comprising (a) a server and (b) a service broker to which a service installed on the computing device registers its published name and which receives a message sent from the first computing device, the message specifying that published name;
wherein the published name of the service conforms to a structured naming convention that uniquely identifies the service as a service from a particular vendor, but without specifying the connection point address of that service, to enable the service broker to start up the service without the risk of a clash.

13. The device of claim 12 in which the service broker is programmed such that the structured naming convention uses reversed domain information.

14. The device of claim 12 in which the service broker uses a single well-known port number address.

15. The device of claim 12 in which the service obtains a connection point and informs the service broker of the connection point address and the service broker then informs the client of the connection point address.

16. The device of claim 15 in which the service broker informs the client of the connection point address and the client then uses that address in communicating directly with the server.

17. The device of claim 15 in which the connection point address is a port number.

18. The device of claim 15 in which, if a service is required more than once, the server providing the service will not be re-started, but instead the service broker uses cached address information.

19. The device of claim 12 in which, when services register with the service broker, they register a version number to indicate the version of the service that they are providing.

20. The device of claim 19 in which the client can request a specific version of a named service or it can omit the version, in which case the service broker will start the highest version available of the named service.

21. The device of claim 12 in which the service broker can serve external clients that are PCs or other computers connected by a local link such as cable, Infra-Red or short distance radio (such as Bluetooth) or by a remote link such as a network data connection.

22. The device of claim 12 in which the service broker provides authentication information such that only authenticated external clients can access services.
